(19) United States
(12) Patent Application Publication
(10) Pub. No.: US 2010/0164426 A1
(43) Pub. Date: Jul. 1, 2010

(54) Stepping motor control circuit and analogue electronic watch

(76) Inventors: Keishi Honmura, Chiba-shi (JP); Saburo Manaka, Chiba-shi (JP); Kenji Ogasawara, Chiba-shi (JP); Takanori Hasegawa, Chiba-shi (JP); Kosuke Yamamoto, Chiba-shi (JP); Kazumi Sakumoto, Chiba-shi (JP); Kazuo Kato, Chiba-shi (JP); Akira Takakura, Chiba-shi (JP)

Correspondence Address: BRUCE L. ADAMS, ESQ;ADAMS & WILKS, SUITE 1231, 17 BATTERY PLACE, NEW YORK, NY, 10004, US

(21) Appl. No.: 12/653,540

(22) Filed: Dec. 15, 2009

(30) Foreign Application Priority Data
Dec. 25, 2008 (JP) 2008-330481

(51) Int. Cl. H02P 8/38; G04B 19/04

(52) U.S. Cl. 318/696; 368/80

(57) ABSTRACT

A detecting period of a stepping motor is divided into a first segment for detecting an induced signal generated at least in a second quadrant by the rotation of a rotor immediately after the driving of a main driving pulse, a second segment being provided after the first segment for detecting the induced signal in a third quadrant, and a third segment provided after the second segment and the control circuit drives the stepping motor by the predetermined fixed main driving pulse having energy not smaller than the maximum energy when a rotation detecting circuit does not detect the induced signal exceeding a reference threshold voltage in the second segment at the time of the rotational driving by the main driving pulse having the maximum energy.

### BACKGROUND OF THE INVENTION

1. Technical Field

The present invention relates to a stepping motor control circuit and an analogue electronic watch using the stepping motor control circuit.

2. Description of the Related Art

In the related art, in an analogue electronic watch or the like, a stepping motor including a stator having a rotor storage hole and a positioning portion for determining a stop position of a rotor, the rotor disposed in the rotor storage hole, and a coil, in which the rotor is rotated by causing the stator to generate a magnetic flux by supplying alternating signals to the coil, and the rotor is stopped at a position corresponding to the positioning portion is used.

As a low consumption driving system of the stepping motor, a correction driving system for a stepping motor including a main driving pulse having small energy in the normal state and a correction driving pulse having large energy which takes a charge of driving when the load is fluctuated is now in practical application.

In the correction driving system, the energy of the main driving pulse used for driving is reduced or increased according to rotation/no-rotation, so that the rank of the main driving pulse is changed so as to drive the stepping motor with minimum energy (see JP-B-61-15385). As a method of determining the rotation/no-rotation of the stepping motor, determination by an induced signal voltage value is generally employed. However, a method in which the induced signal voltage value and an induced signal output time-of-day are combined is also proposed (see WO2005/119377).

In general, the correction driving system is configured as follows.

(1) A main driving pulse P1 is outputted to one pole OUT1 of the coil, and an induced signal voltage generated in the coil is detected by a rotor vibration immediately thereafter.

(2) In a case where the induced signal voltage exceeds an arbitrarily set reference threshold voltage, it is determined to be “rotation”, and the main driving pulse P1 having the energy held constant is outputted to the other pole OUT2 of the coil to drive the stepping motor to rotate, and the same process is repeated by a certain number of times as long as the stepping motor is rotated. When the number of times reaches a certain number of times (PCD), the main driving pulse P1 further reduced in energy is outputted to the other pole, and this process is repeated again.

(3) In a case where the induced signal voltage does not exceed the reference threshold voltage, it is determined “no-rotation”, and a correction driving pulse P2 having the large energy is outputted to the same pole immediately, to forcedly rotate the stepping motor. Subsequently, the main driving pulse P1 is moved up to a main driving pulse P1 having slightly larger energy than the main driving pulse P1 which does not cause the rotation, and the main driving pulse P1 is outputted to the other pole to drive the stepping motor to rotate. Thereafter, the procedures from (1) to (3) described above are repeated.

Basically, the stepping motor is configured to be driven by the main driving pulse P1 according to the required energy. When a driving force is lowered due to increase of the load, decrease of the power voltage, or the like, the main driving pulse P1 is moved up by one rank, and is moved up in ranks to a main driving pulse P1max having maximum energy.

As methods of moving the main driving pulse P1 up in ranks, a method of moving the main driving pulse P1 up in ranks for the first time when the driving of the stepping motor by the main driving pulse P1 is brought into “no-rotation”, and a method of moving the main driving pulse P1 up in ranks in advance when a rotating state before the driving by the main driving pulse P1 is brought into “no-rotation” becomes weaker and weaker is generally employed. The former method is configured to output the correction driving pulse P2 immediately when the driving of the stepping motor by the main driving pulse P1 is “no-rotation” to bring the same into rotation and then moves the main driving pulse P1 up in ranks, and the latter is configured to move the main driving pulse P1 up in ranks in advance without outputting the correction drive pulse P2.

However, both methods have problems as follows. That is, in a case where a load having a large moment such as a disc or a thick stick needle is provided for indicating the time-of-day or the like, the main driving pulse P1 is liable to be a state of a “critical rotation” having no reserved capability even when the main driving pulse P1 is moved up in ranks from a main driving pulse P10 having the minimum energy to the P1max having the maximum energy.

However, when the state of high-load is stabilized for a certain time period (predetermined number of times of driving PCD) due to a temporary roughness load (friction loss of a gear train) or the like, the main driving pulse P1 is moved down in ranks to the main driving pulse P1 having small energy, so that unstable driving may be resulted. In particular, it often occurs when the predetermined number of times of driving PCD) is rather short.

For example, when time-of-day hands are not provided or prescribed time-of-day hands are provided as the load of the stepping motor, the main driving pulse P1 is generally enabled to drive the stepping motor to rotate normally (when a rotation detecting period is divided into three segments T1, T2, and T3 from immediately after the start of driving of the stepping motor, a detection pattern of an induced signal VRs (T1, T2, T3) is (0, 1, 0) to (1, 1, 0), by the main driving pulse P10 having the minimum energy.

However, when a disc needle is provided, the rotation of the rotor becomes slower, and the detection pattern of the induced signal VRs becomes (0/1, 1, 1) to (0/1, 0, 1) even when the main driving pulse P1 is the main driving pulse P1max having the maximum energy. Here, “0/1” means “any of them”.

Here, when the rotation of the predetermined detection pattern continues by a predetermined number of times (PCD number of times) even though it is accidental, the pulse is moved down in ranks to a pulse which has further less reserved capacity (pulse down) in spite of the fact that the present notation does not have a reserved capacity even with the main driving pulse P1max with the maximum energy. In this state of driving, the stepping motor is brought into the “no-rotation” state, and hence is driven by the correction driving pulse P2, whereby useless power consumption is disadvantageously resulted.

### SUMMARY OF THE INVENTION

It is an aspect of the invention to restrain an occurrence of useless power consumption by performing a pulse down operation adequately.

According to another aspect of the invention, there is provided a stepping control circuit including: a rotation detecting unit configured to detect an induced signal generated by a rotation of a rotor of a stepping motor and detect whether or not the induced signal exceeds a predetermined reference threshold voltage within a predetermined detecting period; and a control unit configured to perform a pulse drive control for controlling the driving of the stepping motor with one of a plurality of main driving pulses different in energy from each other or a corrective driving pulse having larger energy than the respective main driving pulse according to the result of detection by the rotation detecting unit, in which the detecting period is divided into a first segment for detecting the inducted signal generated at least in a second quadrant by the rotation of the rotor immediately after the driving of the main driving pulse, a second segment being provided after the first segment for detecting the induced signal in a third quadrant, and a third segment being provided after the second segment, and when the rotation detecting unit does not detect the induced signal exceeding the reference threshold voltage in the second segment at the time of rotational driving by the main driving pulse having the maximum energy, the control unit drives the stepping motor with a predetermined fixed main driving pulse having energy not smaller than the maximum energy.

The detecting period is divided into the first segment for detecting the induced signal generated at least in the second quadrant by the rotation of the rotor immediately after the driving of the main driving pulse, the second segment being provided after the first segment for detecting the induced signal in the third quadrant, and the third segment provided after the second segment and, when the rotation detecting unit does not detect the induced signal exceeding the reference threshold voltage in the second segment at the time of the rotational driving by the main driving pulse having the maximum energy, the control unit drives by the predetermined fixed main driving pulse having energy not smaller than the maximum energy.

Preferably, when the rotation detecting unit does not detect the induced signal exceeding the reference threshold voltage in the second segment continuously by a predetermined number of times at the time of rotational driving by the main driving pulse having the maximum energy, the control unit drives the stepping motor with the predetermined fixed main driving pulse having energy not smaller than the maximum energy.

Preferably, when the rotation detecting unit does not detect the induced signal exceeding the reference threshold voltage in the second segment and detects the same in the third segment at the time of rotational driving by the main driving pulse having the maximum energy, the control unit drives the stepping motor with the predetermined fixed main driving pulse having energy not smaller than the maximum energy without performing the driving by the correction driving pulse.

Preferably, when the rotation detecting unit does not detect the induced signal exceeding the reference threshold voltage in the second segment and in the third segment at the time of rotational driving by the main driving pulse having the maximum energy, the control unit drives the stepping motor with the predetermined fixed main driving pulse having energy not smaller than the maximum energy after having performed the driving by the correction driving pulse.

Preferably, the energy of the predetermined main driving pulse is larger than that of the main driving pulse having the maximum energy.

Preferably, when the rotation detecting unit detects the induced signal exceeding the reference threshold voltage in the second segment continuously by the predetermined number of times at the time of rotational driving by the predetermined main driving pulse, the control unit performs the pulse drive control after having changed the main driving pulse to the predetermined main driving pulse.

Preferably, when the driving is performed by fixing the main driving pulse to a predetermined main driving pulse having energy not smaller than the maximum energy, the control unit performs the detection of the rotation with a reduced time width of the second segment.

According to another aspect of the invention, there is provided an analogue electronic watch having a stepping motor configured to drive time-of-day hands to rotate, and a stepping motor control circuit configured to control the stepping motor, in which any one of the above-described stepping motor control circuits is used as the stepping motor control circuit.

According to the motor control circuit in the invention, the occurrence of useless power consumption can be restrained by performing the pulse down operation adequately.

According to the analogue electronic watch in the invention, restrain of the occurrence of useless driving energy is achieved, so that the analogue electronic watch having a small power consumption can be provided.

### BRIEF DESCRIPTION OF THE DRAWINGS

FIG. 1 is a block diagram of an analogue electronic watch according to an embodiment of the invention;

FIG. 2 is a configuration drawing of a stepping motor used in the analogue electronic watch according to the embodiment of the invention;

FIG. 3 is an explanatory drawing for explaining an action of a stepping motor control circuit and the analogue electronic watch according to the embodiment of the invention;

FIG. 4 is a flowchart showing the action of the stepping motor control circuit and the analogue electronic watch according to the embodiment of the invention; and

FIG. 5 is a flowchart showing the action of the stepping motor control circuit and the analogue electronic watch according to another embodiment of the invention.

### BEST MODES FOR CARRYING OUT THE INVENTION

A motor control circuit according to an embodiment of the invention and an analogue electronic watch using the same will be described. In the respective drawings, the same components are designated by the same reference signs.

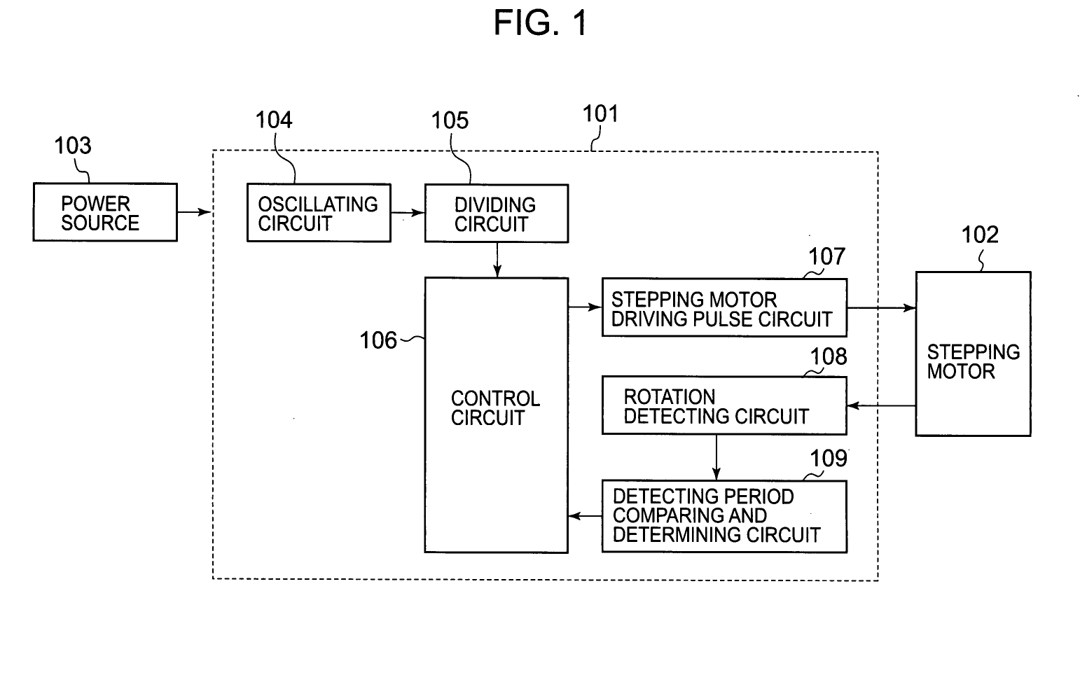

FIG. 1 is a block diagram of the analogue electronic watch using the motor control circuit according to an embodiment of the invention showing and example of an analogue electronic wrist watch. FIG. 1 is a block diagram common to the respective embodiments described later.

In FIG. 1, the analogue electronic watch includes a stepping motor control circuit 101, a stepping motor 102 configured to be controlled by the stepping motor control circuit 101 to rotate for driving time-of-day hands (not shown) or the like to rotate, and a power source 103 formed of a battery for supplying a driving power to circuit elements such as the stepping motor control circuit 101 and the stepping motor 102.

The stepping motor control circuit 101 includes a oscillating circuit 104 configured to generate signals of a predetermined frequency, a dividing circuit 105 configured to divide the signals generated in the oscillating circuit 104 to generate a time signal as a standard of a time count, a control circuit 106 configured to control respective electronic circuit elements which constitute an electronic watch or to control the change of driving pulses, a stepping motor driving pulse circuit 107 configured to select the driving pulse for driving a motor to rotate and output the same to the stepping motor 102 on the basis of a control signal from the control circuit 106, a rotation detecting circuit 108 configured to detect an induced signal which indicates the state of rotation from the stepping motor 102 in a predetermined detecting period, and a detected time comparing and determining circuit 109 configured to compare the time of day and a segment where the rotation detecting circuit 108 detects the induced signal exceeding a predetermined reference threshold voltage and determine the segment where the induced signal is detected. As described later, the detecting period for detecting whether or not the stepping motor 102 is rotated is divided into three segments.

The rotation detecting circuit 108 has the similar configuration to the rotation detecting circuit described in JP-B-61-15385, and detects whether or not the induced signal generated by free vibrations immediately after having driven the stepping motor 102 exceeds a reference threshold voltage Vcomp and, every time when an induced signal VRs exceeding the reference threshold voltage Vcomp is detected, notifies the same to the detected time comparing and determining circuit 109.

The oscillating circuit 104 and the dividing circuit 105 constitute a signal generating unit. The rotation detecting circuit 108 and the detected time comparing and determining circuit 109 constitute a rotation detecting unit. The oscillating circuit 104, the dividing circuit 105, the control circuit 106, and the stepping motor driving pulse circuit 107 constitute a control unit.

The rotation detecting unit is capable of detecting whether or not the induced signal generated by the rotation of the stepping motor 102 exceeds the predetermined reference threshold voltage in the predetermined detecting period.

The control unit is capable of controlling to drive the stepping motor 102 by any one of a plurality of main driving pulses having different energy from each other or by a correction driving pulse having larger energy than the respective main driving pulses according to the results of detection by the rotation detecting unit. When the rotation detecting unit does not detect the induced signal exceeding the reference threshold voltage in a second segment of the detecting period at the time of rotational driving by the main driving pulse having the maximum energy, the control unit is capable of driving the stepping motor 102 with a predetermined fixed main driving pulse having energy not smaller than the maximum energy.

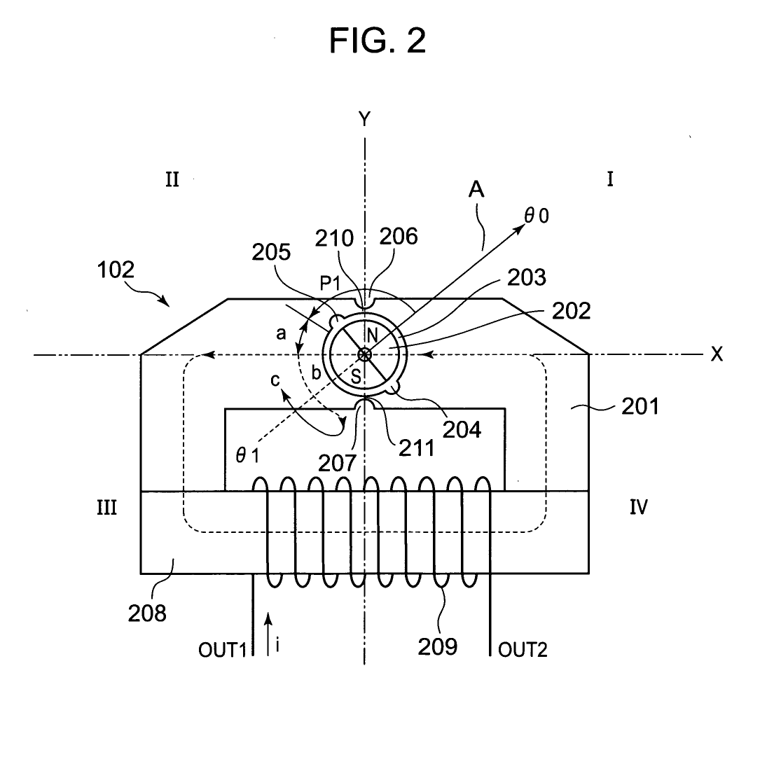

FIG. 2 is a configuration drawing of the stepping motor 102, and shows an example of a stepping motor for a watch which is generally used in the analogue electronic watch.

In FIG. 2, the stepping motor 102 includes a stator 201 having a rotor storage through hole 203, a rotor 202 disposed in the rotor storage through hole 203 so as to be capable of rotating therein, a magnetic core 208 joined to the stator 201, and a coil 209 wound around the magnetic core 208. When the stepping motor 102 is used in the analogue electronic watch, the stator 201 and the magnetic core 208 are fixed to a base panel (not shown) with screws or the like (not shown) and are joined to each other. The coil 209 has a first terminal OUT1 and a second terminal OUT2.

A spatial area where the rotor 202 of the stepping motor 102 rotates is divided into a first quadrant I to a fourth quadrant I about an axis of rotation of the rotor 202.

The rotor 202 is magnetized in two poles (S-pole and N-pole). A plurality of (two in the embodiment) notched portions (outer notches) 206 and 207 are provided on outer end portions of the stator 201 formed of a magnetic material at positions opposing to each other with the intermediary of the rotor storage through hole 203. Provided between the respective outer notches 206 and 207 and the rotor storage through hole 203 are saturable portions 210 and 211.

The saturable portions 210 and 211 are configured not to be magnetically saturated by a magnetic flux of the rotor 202 and to be magnetically saturated when the coil 209 is excited so that the magnetic resistance is increased. The rotor storage through hole 203 is formed into a circular hole shape having a plurality of (two in the embodiment) semicircular notched portions (inner notches) 204 and 205 integrally formed at opposed portions of the through hole having a circular contour.

The notched portions 204 and 205 constitute positioning portions for positioning a stop position of the rotor 202. In a state in which the coil 209 is not excited, the rotor 202 is stably stopped at a position corresponding to the above-described positioning portions, in other words, at a position where the direction of magnetic pole A of the rotor 202 extends orthogonally to a line segment connecting the notched portions 204 and 205 as shown in FIG. 2. In other words, the rotor 202 is stably stopped at a position of an angle θ0 with respect to the direction X of flow of magnetic flux.

When the stepping motor driving pulse circuit 107 supplies a rectangular wave driving pulse to between terminals OUT1 and OUT2 of the coil 209 (for example, the first terminal OUT1 side is the positive pole and the second terminal OUT2 side is the negative pole), and allows a current i to flow in the direction indicated by an arrow in FIG. 2, the magnetic flux in the direction of an arrow of a broken line is generated in the stator 201. Accordingly, the saturable portions 210 and 211 are saturated, and the magnetic resistance is increased, and then the rotor 202 rotates in a direction indicated by the arrow in FIG. 2 by 180° by a mutual action between a magnetic pole generated in the stator 201 and a magnetic pole of the rotor 202, and stops stably at an angular position θ1.

Subsequently, when the driving pulse selecting circuit 107 supplies the rectangular wave driving pulse having an opposite polarity to terminals OUT1 and OUT2 of the coil 209 (the first terminal OUT1 side is the negative pole and the second terminal OUT2 side is the positive pole, so that the polarity is inverted from the driving described above), and allows a current to flow in the opposite direction from that indicated by the arrow in FIG. 2, the magnetic flux in the opposite direction from that indicated by the arrow of the broken line is generated in the stator 201. Accordingly, the saturable portions 210 and 211 are saturated first, and then the rotor 202 rotates in the same direction as that described above by 180° by the mutual action between the magnetic pole generated in the stator 201 and the magnetic pole of the rotor 202, and stops stably at an angular position θ1.

In this manner, by supplying the signals having different polarities (alternating signals) to the coil 209, the operation is repeatedly performed, so that the rotor 202 is rotated continuously in the direction indicated by the arrow by 180° each. In the embodiment, a plurality of main driving pulses P1 and a correction driving pulse P2 having energies different from each other are used as the driving pulses as described later.

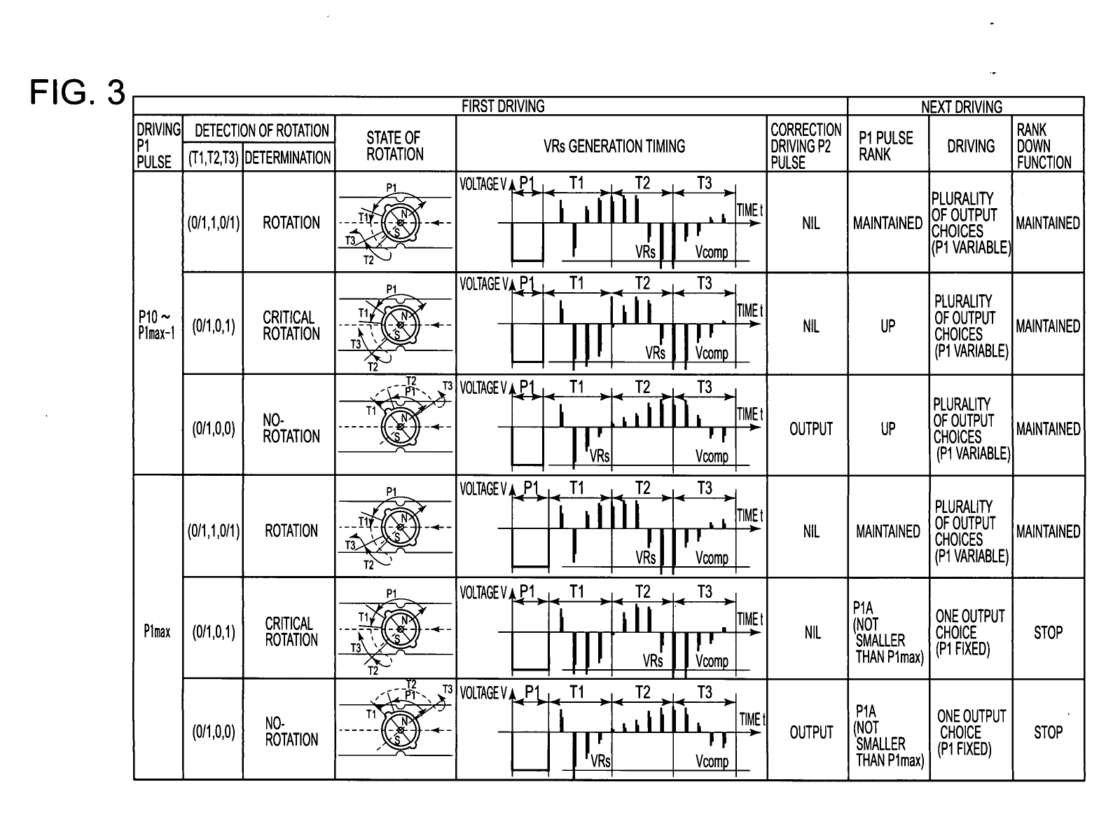

FIG. 3 is an explanatory drawing showing a state of rotation of the rotor 202, timings of occurrence of the induced signal VRs, and a mode of control of the driving pulse when the stepping motor 102 is driven to rotate by the main driving pulse P1.

In FIG. 3, reference sign Vcomp designates the reference threshold voltage as a voltage reference to be compared with the induced signal generated by the stepping motor 102.

The spatial area where the rotor 202 of the stepping motor 102 rotates is divided into the first quadrant I to the fourth quadrant IV (see FIG. 2) about the axis of rotation of the rotor 202, and a rotation detecting period T for detecting the state of rotation of the stepping motor 102 is divided into a first segment T1 for detecting the induced signal VRs generated in at least in the second quadrant II by the rotation of the rotor 202 immediately after the driving by the main driving pulse, a second segment T2 provided after the first segment T1 for detecting the induced signal VRs in third quadrant III, and a third segment T3 provided after the second segment T2. In this manner the entire rotation detecting period T is divided into a plurality of segments (three segments T1 to T3 in the embodiment). In the embodiment, a mask segment, which is a segment in which the detection signal is not detected, is not provided.

In FIG. 3, when a range driven by the main driving pulse P1 is designated as a range P1, the first segment T1 is a segment for detecting the induced signal VRs in at least the second quadrant II immediately after the driving by the main driving pulse P1. The second segment and the third segment are segments for detecting the induced signal VRs in the third quadrant III. A case where the induced signal VRs exceeds the reference threshold voltage Vcomp is expressed by “1”, and other cases are expressed by “0”.

In a case where the stepping motor 102 is driven by the main driving pulses P10 to P1max-1 not having the maximum energy, when a detection pattern of the detecting period (the segment T1, the segment T2, and the third segment T3) obtained as the result of detection is (0/1, 1, 0/1) (“0/1” means “any of them”), it is determined that an adequate rotation is achieved, and the driving by the correction driving pulse P2 is not performed and the main driving pulse P1 is maintained for the subsequent driving without being changed.

In a case where the stepping motor 102 is driven by the main driving pulses P10 to P1max-1 not having the maximum energy, when the detection pattern is (0/1, 0, 1), it is determined that the stepping motor 102 is in rotation, but the driving energy of the main driving pulse P1 is not sufficient (critical rotation), so that the state of no-rotation may occur in the subsequent driving, and hence the main driving pulse P1 is moved up by one rank (pulse-up) at the time of the subsequent driving without driving by the correction driving pulse P2.

In a case where the stepping motor 102 is driven by the main driving pulses P10 to P1max-1 not having the maximum energy, when the detection pattern is (0/1, 0, 0), it is determined that the stepping motor 102 is not rotated (no-rotation), so that the stepping motor 102 is driven by the correction driving pulse P2 and then the pulse-up operation is performed on the main driving pulse P1 at the time of the subsequent driving.

In contrast, in a case where the stepping motor 102 is driven by a main driving pulse P1max having the maximum energy, when the detection pattern is (0/1, 1, 0/1), it is determined that the stepping motor 102 is rotated with a reserved capacity, so that the driving by the correction driving pulse P2 is not performed, and the main driving pulse P1 is maintained for the subsequent driving without being changed.

In a case where the stepping motor 102 is driven by the main driving pulse P1max having the maximum energy, when the detection pattern is (0/1, 0, 1), it is determined that the rotation is the critical rotation, so that the state of no-rotation may occur in the subsequent driving, and hence the pulse-up of the main driving pulse P1 to a main driving pulse P1A having energy not smaller than the main driving pulse P1max having the maximum energy is performed at the time of the subsequent driving without driving by the correction driving pulse P2, and the main driving pulse P1A is fixed for driving from then onward. The main driving pulse P1A is a main driving pulse having the same as or larger than the energy of the main driving pulse P1max having the maximum energy, and is a driving pulse having energy smaller than the correction driving pulse P2.

In a case where the stepping motor 102 is driven by the main driving pulse P1max having the maximum energy, when the detection pattern is (0/1, 0, 0), it is determined to be no-rotation, then the driving by the correction drive pulse P2 is performed, and then the pulse-up of the main driving pulse P1 to the main driving pulse P1A having energy not smaller than the main driving pulse P1max having the maximum energy is performed at the time of the subsequent driving, and the main driving pulse P1A is fixed for driving from then onward.

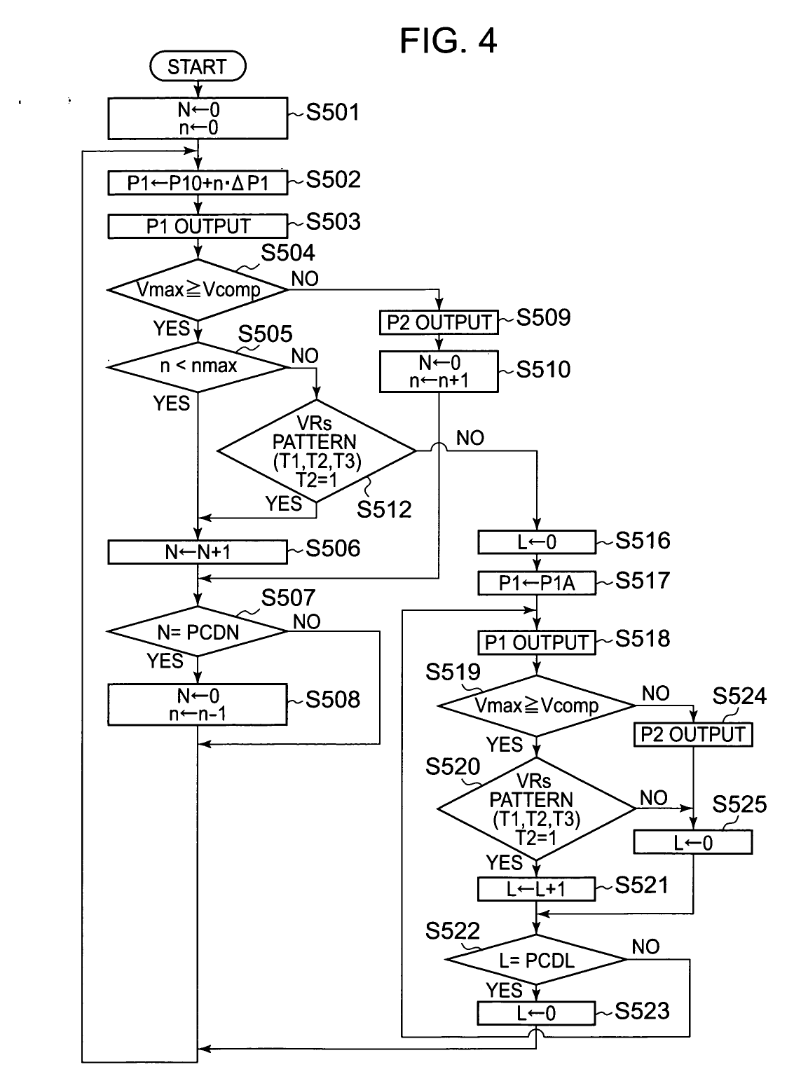

FIG. 4 is a flowchart showing the operation of the stepping motor control circuit and the analogue electronic watch according to the embodiment of the invention, and is a flowchart showing mainly the process of the control circuit 106.

In FIG. 4, reference sign L designates a number of times of continuous repetition (positive integers from a minimum value “0” to a maximum value “PCDL”) of the driving by the same main driving pulse P1, reference sign N designates a number of times of continuous repetition (positive integers from a minimum value “0” to a maximum value “PCDN”) of the driving by the same main driving pulse P1, reference sign n designates a number of ranks of the main driving pulse P1 (the number corresponding to the energy ranks of the main driving pulse P1, positive integers from a minimum value “0” to a maximum value “nmax”), reference sign Vcomp designates the reference threshold voltage for determining the magnitude of the induced signal VRs, reference sign Vmax designates the maximum value of the induced signal VRs, reference sign ΔP1 designates a pulse reduction width, reference signs T1, T2, T3 designate respectively the first segment, the second segment, and the third segment in the detecting period for detecting the induced signal VRs. In the embodiment, the maximum number of L “PCDL” is set to 600, and the maximum number of N “PCDN” is set to 60.

Referring now to FIG. 1 to FIG. 4, the operation of the stepping motor control circuit and the analogue electronic watch according to the embodiment of the invention will be described in detail.

In FIG. 1, the oscillating circuit 104 generates a reference clock signal of a predetermined frequency, and the dividing circuit 105 divides the signal generated by the oscillating circuit 104 to generate a clock signal as a reference of time count and outputs the same to the control circuit 106.

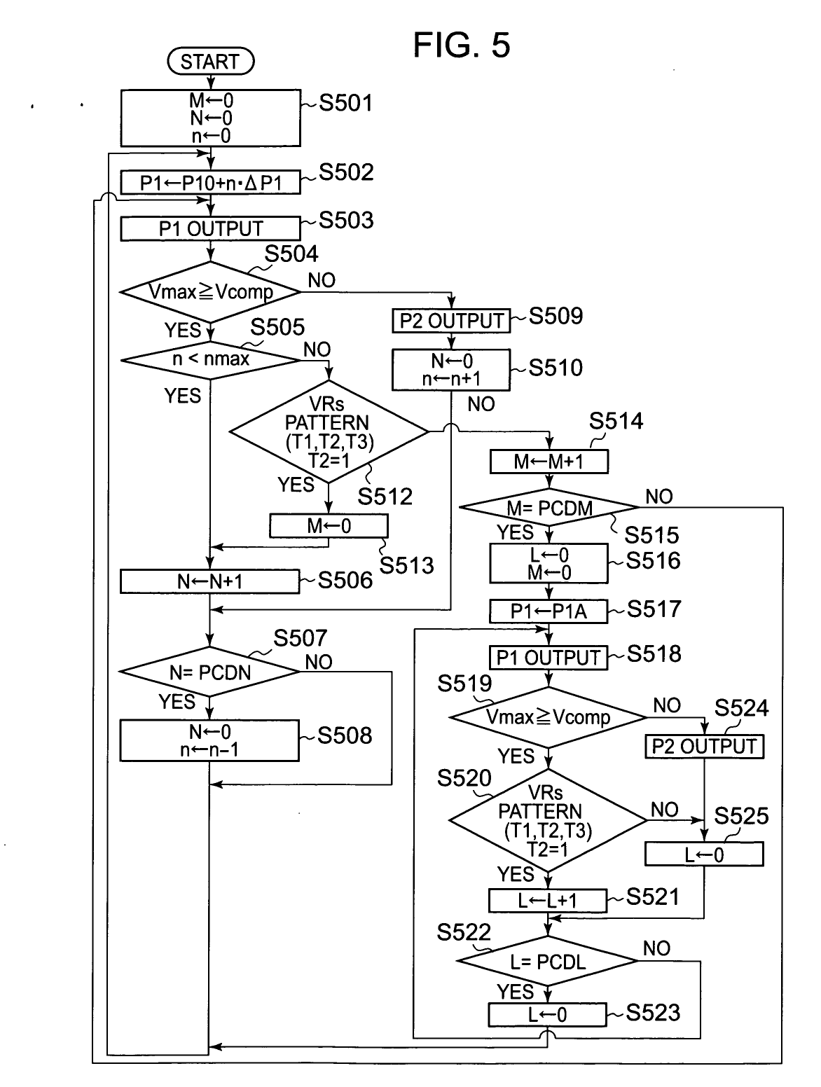

The control circuit 106 counts a time signal and performs a time counting action, and the rank n and the number of times N of a main driving pulse P1n is set to 0 (Step S501 in FIG. 5) first, and outputs the control signal so as to drive the stepping motor 102 to rotate by the main driving pulses P10 having the minimum pulse width (energy) (Steps S502 and 5503).

The stepping motor driving pulse circuit 107 drives the stepping motor 102 to rotate by the main driving pulses P10 in response to the control signal from the control circuit 106. The stepping motor 102 is driven to rotate by the main driving pulse P10 and drives the time-of-day hands or the like, not shown, to rotate. Accordingly, when the stepping motor 102 rotates normally, the current time display and the like by the time-of-day hands is achieved.

When it is determined that the rotation detecting circuit 108 detects the induced signal Vmax of the stepping motor 102 exceeding the predetermined reference threshold voltage Vcomp (Step S504), and that the energy rank n of the main driving pulse P1 is smaller than the energy rank nmax (Step S505), the control circuit 106 increments the number of times of continuous repetition N by one (Step S506). When the number of times of continuous repetition N reaches the maximum number of times of repetition PCDN, it is determined that the energy of the main driving pulse P1 is too large, and the number of times of continuous repetition N is reset to zero, and the energy rank n of the main driving pulse P1 is moved down by one rank (pulse down operation), and then the procedure goes back to Step 5502 (Steps S507, S508).

When it is determined that the energy rank n of the main driving pulse P1 corresponds to the maximum energy rank nmax in the process step S505, if the second segment T2 is “1” in the detection pattern in the detecting period (first segment T1, second segment T2, and third segment T3), the control circuit 106 determines that the rotational driving by the main driving pulse P1 having a reserved capacity in energy is performed, and the procedure goes to the process step S506 (process step S512).

When it is determined that the rotation detecting circuit 108 does not detect the induced signal Vmax of the stepping motor 102 exceeding the predetermined reference threshold voltage Vcomp in the rotation detecting period in the process step S504, the control circuit 106 drives the stepping motor 102 by the correction drive pulse P2 (Step S509), resets the number of times of continuous repetition N to zero, and moves the energy rank n of the main driving pulse P1 up by one rank (pulse-up operation), and then the procedure goes to the process step S507 (Step S510).

In contrast, when the second segment T2 is not “1” in the process step S512, the control circuit 106 resets the number of times of repetition L of the main driving pulse P1 to zero (Step S516), changes the main driving pulse P1 to the main driving pulse P1A having energy not smaller than the main driving pulse P1max having the maximum energy (Step S517), fixes the driving pulse to the main driving pulse P1A, and drives the stepping motor 102 (Step S518).

When it is determined that the rotation detecting circuit 108 detects the induced signal Vmax exceeding the reference threshold voltage Vcomp (Step S519), and at least when the segment T2 of the detection pattern is “1” (Step S520), the control circuit 106 increments the number of times of continuous repetition L by one (Step S521).

When the number of times of repetition L reaches the predetermined number of times (the maximum number of times of repetition PCDL), the control circuit 106 resets the number of times of repetition L, and the procedure goes to the process step 5502 (Steps S522, S523). When the number of times of repetition L does not reach the predetermined number of times PCDL in the processing step S522, the control circuit 106 causes the procedure to go back to the process step S518.

When it is determined that the induced signal Vmax exceeding the reference threshold voltage Vcomp is not detected in the process step S519, the control circuit 106 performs the driving by the correction driving pulse P2 (Step S524), and resets the number of times of repetition L to zero, and then the procedure goes to the process step 5522 (Step S525). When the segment T2 is “0” in the process step S520, the control circuit 106 causes the procedure to go to the process step S525.

As described above, according to the embodiment, the detecting period T is divided into the first segment T1 for detecting the induced signal VRs generated at least in the second quadrant II by the rotation of the rotor 202 immediately after the driving by the main driving pulse P1, the second segment T2 being provided after the first segment T1 for detecting the induced signal VRs in the third quadrant III, and the third segment T3 provided after the second segment T2 and, when the rotation detecting circuit 108 does not detect the induced signal VRs exceeding the reference threshold voltage Vcomp in the second segment T2 even once at the time of the rotational driving by the main driving pulse P1max having the maximum energy (energy rank nmax), the driving pulse is fixed to the main driving pulse P1A having energy not smaller than the maximum energy for the driving (Steps S505, S512, S516, S517).

Therefore, according to the motor control circuit in the embodiment, the occurrence of useless power consumption can be restrained by performing the pulse down operation adequately. Also, a correction drive control of the stepping motor 102 can be performed reliably and stably.

According to the analogue electronic watch in the embodiment, restrain of the occurrence of useless driving energy is achieved, so that the analogue electronic watch having small power consumption can be provided. Also, there is an advantage such that various types of needles can be supported by the same movement of the electronic watch without changing an integrated circuit (IC) or motor specifications.

When the rotation detecting circuit 108 detects the induced signal VRs exceeding the reference threshold voltage Vcomp in the second segment T2 continuously by a predetermined number of times (the number of times of repetition L in the embodiment) at the time of rotational driving by the main driving pulse P1A, the control circuit 106 changes the driving pulse to a predetermined main driving pulse (P1max in the embodiment), and then performs the normal pulse control driving action again. Accordingly, reduction of power consumption is enabled.

FIG. 5 is a flowchart showing the action of the stepping motor control circuit and the analogue electronic clock according to another embodiment of the invention, and is a flowchart showing mainly the process of the control circuit 106.

In FIG. 5, reference sign L designates the number of times of continuous repetition of the driving by the same main driving pulse P1 (positive integers from a minimum value “0” to a maximum value “PCDL”), and reference signs M and N designate the number of times of continuous repetition of the driving by the same main driving pulse P1 (positive integers from the minimum value “0” to a maximum value “PCDM” and a maximum value “PCDN”), reference sign n designates the number ranks of the main driving pulse P1 (a number corresponding to the energy rank of the main driving pulse P1, positive integers from the minimum value “0” to the maximum value “nmax”), reference sign Vcomp designates the reference threshold voltage for determining the magnitude of the induced signal VRs, reference sign Vmax designates the maximum value of the induced signal VRs, reference sign ΔP1 designates a pulse reduction width, and reference signs T1, T2 and T3 designate the first segment, the second segment, and the third segment in the detecting period for detecting the induced signal VRs. In the embodiment, the maximum number of L “PCDL” is set to 600, and the maximum numbers of M and N, “PCDM” and “PCDN” are set to 60, respectively.

According to the embodiment shown in FIG. 4, when the rotation detecting circuit 108 does not detect the induced signal VRs exceeding the reference threshold voltage Vcomp even once in the second segment T2 at the time of rotational driving by the main driving pulse P1max having the maximum energy, the main driving pulse is immediately fixed to the predetermined main driving pulse P1A having energy not smaller than the maximum energy for the driving. In contrast, in the another embodiment, when the induced signal VRs exceeding the reference threshold voltage Vcomp cannot be detected continuously by a plurality of times in the second segment T2, the driving pulse is fixed to the main driving pulse P1A having energy not smaller than the maximum energy for the driving.

Referring now to FIG. 1 to FIG. 3 and FIG. 5, actions of the stepping motor control circuit and the analogue electronic watch according to the another embodiment of the invention will be described relating to portions different from the above-described embodiment.

In FIG. 5, the control circuit 106 sets the rank n and the number of times M and N of the main driving pulse P1n to zero, respectively (Step S501).

When the segment T2 is “1” in the process step S512, the control circuit 106 resets the number of times of repetition M to zero, and then causes the procedure to go back to the process step S506 (Step S513).

When the segment T2 is “0” in the process step S512, the control circuit 106 increments the number of times of repetition M of the main driving pulse P1 by one (Step S514), and determines whether or not the number of times of repetition M reaches the maximum number of times of repetition PCDM (Step S515).

When the number of times of repetition M does not reach the maximum number of times of repetition PCDM in the process step S515, the control circuit 106 causes the procedure to go back to the process step S503 and, when the number of times of repetition M reaches the maximum number of times of repetition PCDM, the control circuit 106 resets the numbers of times of repetition M and L of the main driving pulse P1 to zero respectively (Step S516), changes the main driving pulse P1 to the main driving pulse P1A having energy not smaller than the main driving pulse P1max having the maximum energy (Step S517), and drives the stepping motor 102 by the main driving pulse P1A (Step S518). From then onward, the same processes as the embodiment described above are performed.

As described above, according to the another embodiment, the detecting period T is divided into the first segment T1 for detecting the induced signal VRs generated at least in the second quadrant II by the rotation of the rotor 202 immediately after the driving by the main driving pulse P1, the second segment T2 being provided after the first segment T1 for detecting the induced signal VRs in the third quadrant III, and the third segment T3 provided after the second segment T2 and, when the rotation detecting circuit 108 does not detect the induced signal VRs exceeding the reference threshold voltage Vcomp in the second segment T2 continuously by the predetermined number of times (the plurality of times M in the another embodiment) at the time of the rotational driving by the main driving pulse P1max having the maximum energy (energy rank nmax), the driving pulse is fixed to the main driving pulse P1A having energy not smaller than the maximum energy for the driving (Steps S505, S512, S514 to S517).

Therefore, according to the motor control circuit in the another embodiment, the occurrence of useless power consumption can be restrained by performing the pulse down operation adequately. According to the analogue electronic watch in the another embodiment, restrain of the occurrence of useless driving energy is achieved, so that the analogue electronic watch having small power consumption can be provided.

In the same manner as the embodiment described above, when the rotation detecting circuit 108 detects the induced signal VRs exceeding the reference threshold voltage Vcomp in the second segment T2 continuously by a predetermined number of times (the number of times of repetition L in the another embodiment) at the time of rotational driving by the main driving pulse P1A, the control circuit 106 changes the driving pulse to a predetermined main driving pulse (P1max in the another embodiment), and then performs the pulse control. Accordingly, power saving is achieved.

In the embodiments described above, the energy of the main driving pulse P1 is changed by differentiating a pulse width. However, the driving energy can be changed also by changing the pulse voltage or the like.

The control circuit 106 may be configured to reduce the time width of the second segment T2 with respect to the first segment and the third segment when the main driving pulse P1 is fixed to P1A, and perform a control to change the main driving pulse P1 (PCD control) when the stable driving is achieved under such conditions as well (when the detection pattern is (0/1, 1, 0/1)). In this manner, the conditions to enter the stable driving are made more strict by reducing the width of the second segment T2 so that the control to change the main driving pulse P1 is restored only when the stable driving is achieved under such strict conditions, whereby useless execution of the driving by the correction driving pulse is avoided to achieve the power saving.

The invention is also applicable to a stepping motor for driving a calendar or the like instead of the time-of-day hands.

Also, although the electronic watch has been described as the example of the application of the stepping motor, it may be applicable to the electronic instruments using the motor.

The stepping motor control circuit according to the invention may be applicable to various electronic instruments using the stepping motor.

The electronic watch according to the invention is applicable to various analogue electronic clocks with a calendar function such as analogue electronic standing clocks with a calendar functions or analogue electronic watches with a calendar function, as well as various analogue electronic clocks.

What is claimed is:

1. A stepping motor control circuit comprising:
a rotation detecting unit configured to detect an induced signal generated by a rotation of a rotor of a stepping motor and detect whether or not the induced signal exceeds a predetermined reference threshold voltage within predetermined detecting period; and a control unit configured to perform a pulse drive control for controlling the driving of the stepping motor with one of a plurality of main driving pulses different in energy from each other or a corrective driving pulse having larger energy than the respective main driving pulse according to the result of detection by the rotation detecting unit, wherein
the detecting period is divided into a first segment for detecting the induced signal generated in at least a second quadrant by the rotation of the rotor immediately after the driving of the main driving pulse, a second segment being provided after the first segment for detecting the induced signal in a third quadrant, and a third segment being provided after the second segment, and
when the rotation detecting unit does not detect the induced signal exceeding the reference threshold voltage in the second segment at the time of rotational driving by the main driving pulse having the maximum energy, the control unit drives the stepping motor with a predetermined fixed main driving pulse having energy not smaller than the maximum energy.

2. A stepping motor control circuit according to claim 1, wherein when the rotation detecting unit does not detect the induced signal exceeding the reference threshold voltage in the second segment continuously by a predetermined number of times at the time of rotational driving by the main driving pulse having the maximum energy, the control unit drives the stepping motor with the predetermined fixed main driving pulse having energy not smaller than the maximum energy.

3. A stepping motor control circuit according to claim 1, wherein when the rotation detecting unit does not detect the induced signal exceeding the reference threshold voltage in the second segment and detects the same in the third segment at the time of rotational driving by the main driving pulse having the maximum energy, the control unit drives the stepping motor with the predetermined fixed main driving pulse having energy not smaller than the maximum energy without performing the driving by the correction driving pulse.

4. A stepping motor control circuit according to claim 2, wherein when the rotation detecting unit does not detect the induced signal exceeding the reference threshold voltage in the second segment and detects the same in the third segment at the time of rotational driving by the main driving pulse having the maximum energy, the control unit drives the stepping motor with the predetermined fixed main driving pulse having energy not smaller than the maximum energy without performing the driving by the correction driving pulse.

5. A stepping motor control circuit according to claim 1, wherein when the rotation detecting unit does not detect the induced signal exceeding the reference threshold voltage in the second segment and in the third segment at the time of rotational driving by the main driving pulse having the maximum energy, the control unit drives the stepping motor with the predetermined fixed main driving pulse having energy not smaller than the maximum energy after having performed the driving by the correction driving pulse.

6. A stepping motor control circuit according to claim 2, wherein when the rotation detecting unit does not detect the induced signal exceeding the reference threshold voltage in the second segment and in the third segment at the time of rotational driving by the main driving pulse having the maximum energy, the control unit drives the stepping motor with the predetermined fixed main driving pulse having energy not smaller than the maximum energy after having performed the driving by the correction driving pulse.

7. A stepping motor control circuit according to claim 3, wherein when the rotation detecting unit does not detect the induced signal exceeding the reference threshold voltage in the second segment and in the third segment at the time of rotational driving by the main driving pulse having the maximum energy, the control unit drives the stepping motor with the predetermined fixed main driving pulse having energy not smaller than the maximum energy after having performed the driving by the correction driving pulse.

8. A stepping motor control circuit according to claim 4, wherein when the rotation detecting unit does not detect the induced signal exceeding the reference threshold voltage in the second segment and in the third segment at the time of rotational driving by the main driving pulse having the maximum energy, the control unit drives the stepping motor with the predetermined fixed main driving pulse having energy not smaller than the maximum energy after having performed the driving by the correction driving pulse.

9. A stepping motor control circuit according to claim 1, wherein the energy of the predetermined main driving pulse is larger than that of the main driving pulse having the maximum energy.

10. A stepping motor control circuit according to claim 2, wherein the energy of the predetermined main driving pulse is larger than that of the main driving pulse having the maximum energy.

11. A stepping motor control circuit according to claim 3, wherein the energy of the predetermined main driving pulse is larger than that of the main driving pulse having the maximum energy.

12. A stepping motor control circuit according to claim 4, wherein the energy of the predetermined main driving pulse is larger than that of the main driving pulse having the maximum energy.

13. A stepping motor control circuit according to claim 5, wherein the energy of the predetermined main driving pulse is larger than that of the main driving pulse having the maximum energy.

14. A stepping motor control circuit according to claim 6, wherein the energy of the predetermined main driving pulse is larger than that of the main driving pulse having the maximum energy.

15. A stepping motor control circuit according to claim 7, wherein the energy of the predetermined main driving pulse is larger than that of the main driving pulse having the maximum energy.

16. A stepping motor control circuit according to claim 8, wherein the energy of the predetermined main driving pulse is larger than that of the main driving pulse having the maximum energy.

17. A stepping motor control circuit according to claim 1, wherein when the rotation detecting unit detects the induced signal exceeding the reference threshold voltage in the second segment continuously by the predetermined number of times at the time of rotational driving by the predetermined main driving pulse, the control unit performs the pulse drive control after having changed the main driving pulse to the predetermined main driving pulse.

18. A stepping motor control circuit according to claim 1, wherein when the driving is performed by fixing the main driving pulse to a predetermined main driving pulse having energy not smaller than the maximum energy, the control unit performs the detection of the rotation with a reduced time width of the second segment.

19. An analogue electronic watch having a stepping motor configured to drive time-of-day hands to rotate, and a stepping motor control circuit configured to control the stepping motor, wherein
the stepping motor control circuit according to claim 1 is used as the stepping motor control circuit.
